(19) United States
(12) Patent Application Publication
(10) Pub. No.: US 2008/0197772 A1
(43) Pub. Date: Aug. 21, 2008

(54) Display apparatus and method of fabricating the same

(76) Inventors: Mun-Ho Nam, Suwon-si (KR); Seung-Hyun Son, Suwon-si (KR); Hyoung-Bin Park, Suwon-si (KR); Kwang-Sik Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/006,851

(22) Filed: Jan. 7, 2008

(30) Foreign Application Priority Data
Feb. 16, 2007 (KR) 10-2007-0016755

(51) Int. Cl. H01J 40/06

(52) U.S. Cl. 313/538; 445/47

(57) ABSTRACT

Provided is a display apparatus and a method of fabricating the display apparatus. The display apparatus includes a first substrate that allows visible light to pass therethrough, a second substrate facing the first substrate, an anode disposed on the first substrate, a cathode disposed on the second substrate, an electron emitter disposed either on the anode or the cathode, a light emitting layer formed on a surface of the anode, an optical reflection layer disposed on a side of the second substrate, and a gas that generates ultraviolet rays and is filled in a space between the first substrate and the second substrate. The display apparatus can increase the reflectance of visible light since the optical reflection layer is formed in a sealed inner space of the display apparatus, and thus, brightness and light emission efficiency of the transmissive type or reflective type display apparatus can be increased.

### CROSS-REFERENCE TO RELATED PATENT APPLICATION

This application claims the benefit of Korean Patent Application No. 10-2007-0016755, filed on Feb. 16, 2007, in the Korean Intellectual Property Office, the disclosure of which is incorporated herein in its entirety by reference.

### BACKGROUND OF THE INVENTION

1. Field of the Invention

The present embodiments relate to a display apparatus, and more particularly, to a display apparatus that includes a visible light reflecting layer to increase brightness and light emission efficiency and a method of fabricating the display apparatus.

2. Description of the Related Art

A plasma display panel (PDP) is a flat panel display device that displays desired numbers, letters, or images using visible light emitted from phosphor layers excited by ultraviolet rays generated during a gas discharge initiated by applying a direct or alternate current voltage to a plurality of discharge electrodes formed on a plurality of substrates after a discharge gas is sealed between the plurality of substrates.

Generally, PDPs can be classified into direct current (DC) PDPs and alternating current (AC) PDPs according to the type of the driving voltage applied to discharge cells, i.e., according to the discharge type. PDPs can further be classified into facing discharge PDPs and surface discharge PDPs according to the arrangement of electrodes.

FIG. 1 is a cross-sectional view of a plasma display panel 100. Referring to FIG. 1, the conventional plasma display panel 100 includes a first substrate 101, a second substrate 102 facing the first substrate 101, sustain discharge electrode pairs 105 each having an X electrode 103 and a Y electrode 104 formed on an inner surface of the first substrate 101, a first dielectric layer 106 that buries the sustain discharge electrode pairs 105, a protective film layer 107 formed on a surface of the first dielectric layer 106, a plurality of address electrodes 108 formed on an inner surface of the second substrate 102 in a direction crossing the sustain discharge electrode pairs 105, a second dielectric layer 109 that buries the address electrodes 108, a barrier rib structure 110 formed between the first and second substrate 101 and 102 to define a plurality of discharge cells, and red, green, and blue phosphor layers 111 formed in the discharge cells. An inner space defined by the combination of the first substrate 101 and the second substrate 102 is a discharge space and a discharge gas is filled in the discharge space.

The conventional plasma display panel 100 having the above structure can be readily fabricated using a thick film forming technique such as a printing process. However, due to process limits, it is difficult to display images of high quality and high resolution.

Also, in the conventional plasma display panel 100, visible light is obtained through a series of processes where electrons are continuously produced through discharges, and accelerated electrons collide with neutral particles to generate excited particles that emit vacuum ultraviolet rays, and the vacuum ultraviolet rays excite the phosphor layers 111 to emit visible light.

However, ions that are not advantageous for generating light are produced in the above processes, and energy required to accelerate the ions for generating light is more than half of the total energy consumption, thereby reducing the energy efficiency of the plasma display panel 100. The present embodiments overcome the above-described and other drawbacks of conventional plasma display panel technology and offer additional advantages as well.

### SUMMARY OF THE INVENTION

To address the above and/or other problems, the present embodiments provide a display apparatus having increased brightness and light emission efficiency by forming a visible light reflection layer in a display device that emits electrons and a method of fabricating the display apparatus.

According to an aspect of the present embodiments, there is provided a display apparatus comprising: a first substrate that allows light to pass therethrough; a second substrate facing the first substrate; an anode disposed on the first substrate; a cathode disposed on the second substrate; an electron emitter disposed either on the anode or the cathode; a light emitting layer formed on a surface of the anode; an optical reflection layer disposed on a side of the second substrate; and a gas that generates ultraviolet rays and is filled in a space between the first substrate and the second substrate.

The electron emitter may be disposed on the anode.

The electron emitter may be disposed on the cathode.

The optical reflection layer may be formed in a region where electrons are not transmitted.

The optical reflection layer may be formed to have one or more layers using a white dielectric layer or a thin film metal layer.

According to an aspect of the present embodiments, there is provided a method of fabricating a display apparatus, comprising: patterning an electrode on a substrate; aligning a shadow mask on the substrate by separating a portion of the substrate where the electrode is formed and a portion of the substrate where the electrode is not formed; and selectively forming an optical reflection layer on the substrate except the region on the electrode which is shielded by the shadow mask.

According to another aspect of the present embodiments, there is provided a method of fabricating a display apparatus, comprising: patterning an electrode on a substrate; coating a photoresist layer covering the electrode on the substrate; patterning the photoresist layer on a region of the substrate corresponding to the electrode by exposing and developing the substrate; forming an optical reflection layer on the substrate; and removing the remaining photoresist layer.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a cross-sectional view of a display apparatus;

FIG. 2 is cross-sectional view illustrating a display apparatus according to an embodiment;

FIG. 3 is a cross-sectional view illustrating a display apparatus according to another embodiment;

FIG. 4 is a cross-sectional view illustrating a display apparatus according to another embodiment;

FIGS. 5A through 5D are cross-sectional views for illustrating a method of fabricating the display apparatus of FIG. 2, according to an embodiment;

FIG. 5A is a cross-sectional view illustrating a patterned electrode on a substrate of the display apparatus of FIG. 2, according to an embodiment;

FIG. 5B is a cross-sectional view illustrating an aligned mask on the substrate of FIG. 5A, according to an embodiment;

FIG. 5C is a cross-sectional view illustrating coating of a raw material of an optical reflection layer on the substrate of FIG. 5B, according to an embodiment;

FIG. 5D is a cross-sectional view illustrating an optical reflection layer formed on the substrate of FIG. 5C, according to an embodiment;

FIGS. 6A through 6E are cross-sectional views for illustrating a method of fabricating the display apparatus of FIG. 3, according to another embodiment;

FIG. 6A is a cross-sectional view illustrating a patterned electrode on a substrate of the display apparatus of FIG. 3, according to another embodiment;

FIG. 6B is a cross-sectional view illustrating a photoresist layer coated on the substrate of FIG. 6A, according to another embodiment;

FIG. 6C is a cross-sectional view illustrating the photoresist layer patterned on the substrate of FIG. 6B, according to another embodiment;

FIG. 6D is a cross-sectional view illustrating a raw material for an optical reflection layer coated on the substrate of FIG. 6C, according to another embodiment; and

FIG. 6E is a cross-sectional view illustrating an optical reflection layer formed on the substrate of FIG. 6D, according to another embodiment.

### DETAILED DESCRIPTION OF THE INVENTION

The present embodiments will now be described more fully with reference to the accompanying drawings in which exemplary embodiments are shown.

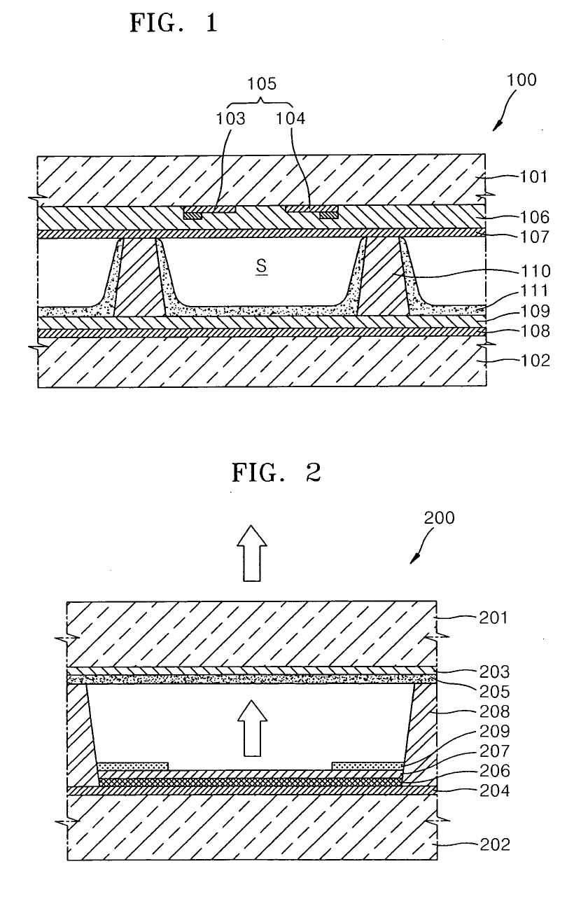

FIG. 2 is cross-sectional view illustrating a transmissive type display apparatus 200 according to an embodiment.

Referring to FIG. 2, the transmissive type display apparatus 200 includes a first substrate 201 and a second substrate 202 disposed parallel to the first substrate 201. Frit glass (not shown) is coated along edges of inner surfaces of the first substrate 201 and the second substrate 202 to form an inner sealed space.

An anode 203 is formed on an inner surface of the first substrate 201. A light emitting layer 205 is formed on a lower surface of the anode 203. A cathode 204 is formed on an inner surface of the second substrate 202. An electron emitter 206 is formed on a surface of the cathode 204. A grid electrode 207 is formed on a surface of the electron emitter 206.

A barrier rib structure 208 is formed between the first substrate 201 and the second substrate 202. The inner space defined by the combination of the first substrate 201, the second substrate 202, and the barrier rib structure 208 is filled with a gas. The gas may be a gas mixture in which Xe gas is mixed with one or more of He gas, Ar gas, and Ne gas.

The gas to be filled in the sealed inner space can be any gas that can generate ultraviolet rays when excited by electrons emitted from the electron emitter 206. That is, besides the gas mixture that includes the Xe gas, various gases, for example, N₂, heavy hydrogen, CO₂, H₂ gas, CO, or Kr, or air, can be used.

The transmissive type display apparatus 200 further includes an optical reflection layer 209. The moving direction of electrons emitted from the electron emitter 206 and the transmission direction of visible light are substantially identical to each other.

The first substrate 201 and the second substrate 202 can independently be a transparent substrate such as a soda lime glass, a semi-transparent substrate, a reflective substrate, or a colored substrate. Since visible light must pass through the first substrate 201, the first substrate 201 may be formed of a material having high transmittance.

The anode 203, the cathode 204, and the grid electrode 207 can be formed of a transparent conductive film such as an indium tin oxide (ITO) film, or a metal film having high conductivity such as Ag or Al.

The light emitting layer 205 is formed to cover the anode 203, and is a photo luminescence (PL) phosphor layer that emits visible light by a photoluminescence mechanism in which the visible light is emitted due to re-stabilization of electrons excited by absorbing ultraviolet rays generated from a gas excited by electrons emitted from the electron emitter 206.

The light emitting layer 205 is formed of a material having high light emission efficiency at a wavelength of about 147 nm so that the material can be excited by vacuum ultraviolet rays of wavelength of about 147 nm that are generated from the Xe gas. The light emitting layer 205 includes sub-pixels of a red light emitting layer, a green light emitting layer, and a blue light emitting layer formed in each of the sealed inner spaces to display a color image.

The red light emitting layer may be formed of (Y,Gd)BO₃;Eu⁺³, the green light emitting layer may be formed of Zn₂SiO₄:Mn²⁺, and the blue light emitting layer may be formed of BaMgAl₁₀O₁₇:Eu²⁺. Also, the blue light emitting layer can be formed of a mixture of CaMgSi₂O₈:Eu²⁺ and CaMgSi₂O₈:Eu²⁺ or BaMgAl₁₀O₇:Eu²⁺, but the present embodiment is not limited to the above cases.

Alternatively, the light emitting layer 205 can be a cathode luminescence (CL) phosphor layer that emits visible light when atoms are stabilized after being excited by receiving energy in an ultraviolet rays region, or a quantum dot (QD) phosphor layer.

The CL phosphor layer can be a sulfide based phosphor layer. The QD phosphor layer emits visible light while excited atoms are stabilized at an atom energy level when the atoms receive energy from the outside since there is no interference between the atoms. Accordingly, the atoms can be excited by a low voltage, and thus, light emission efficiency can be increased. Also, the QD phosphor layer can be formed using a printing process, and thus, the fabrication of a large screen is possible.

Thus, the light emitting layer 205 can be a PL phosphor layer, a CL phosphor layer, or a QD phosphor layer. Also, the light emitting layer 205 can be formed by mixing at least two of these three phosphor layers.

The electron emitter 206 covers the cathode 204. The electron emitter 206 can be formed of any material that can generate electron beams by accelerating electrons, and preferably, can be formed of oxidized porous silicon (OPS) or oxidized porous amorphous silicon (OPAS).

Alternatively, the electron emitter 206 can be formed of boron nitride bamboo shoot (BNBS). The BNBS is transparent in a visible light wavelength region of approximately 380 to 780 nm, and has high electron emission characteristics since the BNBS has negative electron affinity.

The grid electrode 207 is formed on a surface of the electron emitter 206. The grid electrode 207 may be formed to a thickness of greater than 0 nm and smaller than about 10 nm when the grid electrode 207 is employed in the transmissive type display apparatus 200 to increase electron emission efficiency.

In this case, since the thickness of the grid electrode 207 is too thin, the grid electrode 207 does not perform as a reflection layer so that visible light generated from the sealed inner space can pass through the first substrate 201. Therefore, the optical reflection layer 209 having a thickness of about 100 nm or more is formed on a region of a surface of the grid electrode 207 except the region of the surface of the grid electrode 207 where electrons pass through.

The optical reflection layer 209 is also formed due to the following reason.

In the transmissive type display apparatus 200, since the light emitting layer 205 is formed on the inner surface of the first substrate 201 through which the visible light passes, a coated area of the light emitting layer 205 is relatively small when compared to a reflective structure, and thus, electrons drifted from the cathode 204 to the anode 203 can be accumulated on the light emitting layer 205. Therefore, the light emitting layer 205 should be formed to be thin.

Accordingly, if the coated area of the light emitting layer 205 is reduced, brightness of the transmissive type display apparatus 200 is reduced. Therefore, in order to increase the reduced brightness, the optical reflection layer 209 is formed to reflect visible light generated in the sealed inner space towards the first substrate 201.

The optical reflection layer 209 can be a white color dielectric layer formed of, for example, Al₂O₃. Alternatively, the optical reflection layer 209 can be a metal layer having high reflectivity such as an Al thin film.

An operation of the transmissive type display apparatus 200 having the above structure will now be described.

First, an image signal received from the outside is transformed into a signal for displaying a desired image through an image process unit (not shown) and a logic control unit (not shown), and is applied to the anode 203, the cathode 204, and the grid electrode 207.

When a voltage is applied to the anode 203, the cathode 204, and the grid electrode 207, electrons emitted from the cathode 204 are injected into the electron emitter 206. At this point, since nanocrystal silicon and nanocrystal silicon interfaces in the electron emitter 206 are covered by a thin oxide film, most of the voltage applied to the electron emitter 206 is applied to the thin oxide film of a surface of the nanocrystal silicon, and thus, a strong electric field region is formed on the surface of the nanocrystal silicon.

Since the oxide film is very thin, electrons readily pass through the oxide thin film due to a tunneling effect, and the electrons are accelerated when the electrons pass through the strong electric field region. Since the acceleration of electrons is repeated towards the grid electrode 207, the electrons can readily pass through the grid electrode 207 due to the tunneling effect, and as a result, electron beams are emitted into the sealed inner space.

The emitted electron beams excite a gas, and the gas generates vacuum ultraviolet rays while the gas is stabilized. The vacuum ultraviolet rays excite the light emitting layer 205 to generate visible light, and the visible light displays an image by being emitted towards the first substrate 201.

In this way, electrons are emitted from the cathode 204 and accelerated towards the anode 203. The vacuum ultraviolet rays are generated using the gas excited by the emitted electrons, and the vacuum ultraviolet rays excite the light emitting layer 205 to emit visible light.

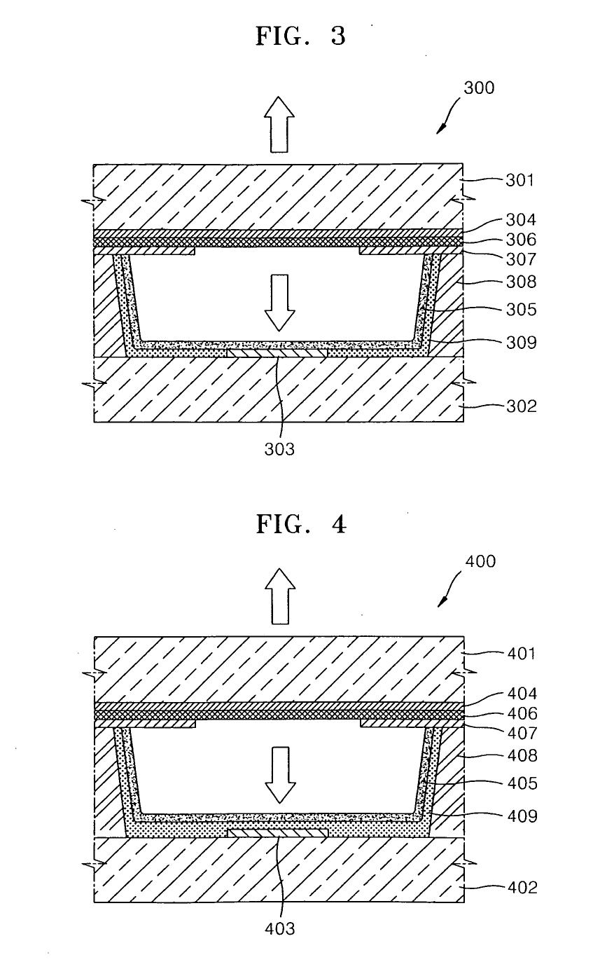

FIG. 3 is a cross-sectional view illustrating a transmissive type display apparatus 300 according to another embodiment.

Referring to FIG. 3, the transmissive type display apparatus 300 includes a first substrate 301 and a second substrate 302 facing the first substrate 301. The first substrate 301 may be a substrate having high transmittance such as, for example, soda lime glass.

A cathode 304 is formed on an inner surface of the first substrate 301, and an anode 303 is formed on an inner surface of the second substrate 302. The first substrate 301 on which the cathode 304 is formed is a substrate through which visible light is emitted. A grid electrode 307 is formed on an electron emitter 306 which is formed on the cathode 304.

A light emitting layer 305 is formed on the anode 303. The light emitting layer 305 is formed in a sealed space which is defined by a barrier rib structure 308. The light emitting layer 305 comprises red, green, and blue PL phosphor layers that can emit visible light when excited by vacuum ultraviolet rays generated by a gas excited by electrons emitted from the electron emitter 306. Alternatively, the light emitting layer 305 can be a CL phosphor layer or a QD phosphor layer.

An optical reflection layer 309 is formed in contact with the light emitting layer 305. That is, the optical reflection layer 309 is formed between the light emitting layer 305 and the second substrate 302. At this point, if the optical reflection layer 309 buries all of the anode 303, electrons can be accumulated on a surface of the light emitting layer 305, and due to the accumulate electrons, a voltage applied to the electrodes can vary. Therefore, a region where the anode 303 is formed contacts the light emitting layer 305, and the optical reflection layer 309 is formed on the second substrate 302 where the anode 303 is not formed.

Also, the optical reflection layer 309 can be interposed between the light emitting layer 305 and the barrier rib structure 308, and can be formed in one unit with the optical reflection layer 309 formed between the light emitting layer 305 and the second substrate 302. Accordingly, the optical reflection layer 309 is formed between the light emitting layer 305 and the second substrate 302 as well as between the light emitting layer 305 and the barrier rib structure 308, but is not limited thereto.

The purpose of the optical reflection layer 309 is to reflect visible light present in the sealed inner space towards the first substrate 301 since, when the visible light generated from the light emitting layer 305 is emitted to the outside through the electron emitter 306 of the first substrate 301, the visible light can be blocked by the electron emitter 306 and the grid electrode 307.

The electron emitter 306 is formed on a surface of the cathode 304. The electron emitter 306 can be formed of any material that can generate electron beams by accelerating electrons, for example, oxidized porous silicon (OPS) or oxidized porous amorphous silicon (OPAS). Alternatively, the electron emitter 206 can be formed of BNBS.

The grid electrode 307 is formed on a surface of the electron emitter 306. In some embodiments, the grid electrode 307 is not formed on the surface of the electron emitter 306 corresponding to the portion of the electron emitter 306 through which electrons pass in order to prevent the visible light from being blocked by the grid electrode 307.

In the transmissive type display apparatus 300 having the above structure, when electrons are emitted from the cathode 304 formed on the inner surface of the first substrate 301, the electrons proceed towards the anode 303 formed on the inner surface of the second substrate 302 by being accelerating while passing through the electron emitter 306 and the grid electrode 307. The emitted electrons excite a gas filled in the sealed inner space to generate vacuum ultraviolet rays, and the vacuum ultraviolet rays excite phosphor layers coated in the sealed inner space to emit visible light. The emitted visible light displays an image by being emitted towards the first substrate 301. In this way, the visible light emitted from the light emitting layer 305 is emitted to the outside through the electron emitter 306.

Electrons blocked by the electron emitter 306 and the grid electrode 307 are reflected by the optical reflection layer 309 formed in contact with the light emitting layer 305 and are emitted towards the first substrate 301.

FIG. 4 is a cross-sectional view illustrating a modified version of the transmissive type display apparatus 300 of FIG. 3.

Referring to FIG. 4, a transmissive type display apparatus 400 according to another embodiment includes a first substrate 401 and a second substrate 402 facing the first substrate 401. A cathode 404 is formed on an inner surface of the first substrate 401 through which visible light is emitted, and an anode 403 is formed on an inner surface of the second substrate 402. A barrier rib structure 408 is formed between the first substrate 401 and the second substrate 402 to form a sealed inner space.

An optical reflection layer 409 is formed on the anode 403, and a light emitting layer 405 is formed on the optical reflection layer 409. Unlike the anode 303 in FIG. 3, the anode 403 is buried by the optical reflection layer 409, and the light emitting layer 405 is formed on a surface of the optical reflection layer 409. The optical reflection layer 409 is formed between the light emitting layer 405 and the second substrate 402 as well as between the light emitting layer 405 and the barrier rib structure 408, but is not limited thereto.

As described above, the optical reflection layer 409 covers the entire anode 403 in order to increase the reflectance of visible light using the optical reflection layer 409 formed of, for example, a thin Al film, and to prevent the accumulation of electrons on a surface of the light emitting layer 405.

The optical reflection layer 409 can be formed using a conventional method such as a thermal deposition method, a chemical vapor deposition (CVD) method, a printing method, a sputtering method, or a spin coating method. However, when the optical reflection layer 409 is formed using the above mentioned methods, the optical reflection layer 409 is formed on the entire surface of the second substrate 402, and thus, it is difficult to pattern it in a particular shape.

A method of fabricating an optical reflection layer according to the present embodiments will now be described.

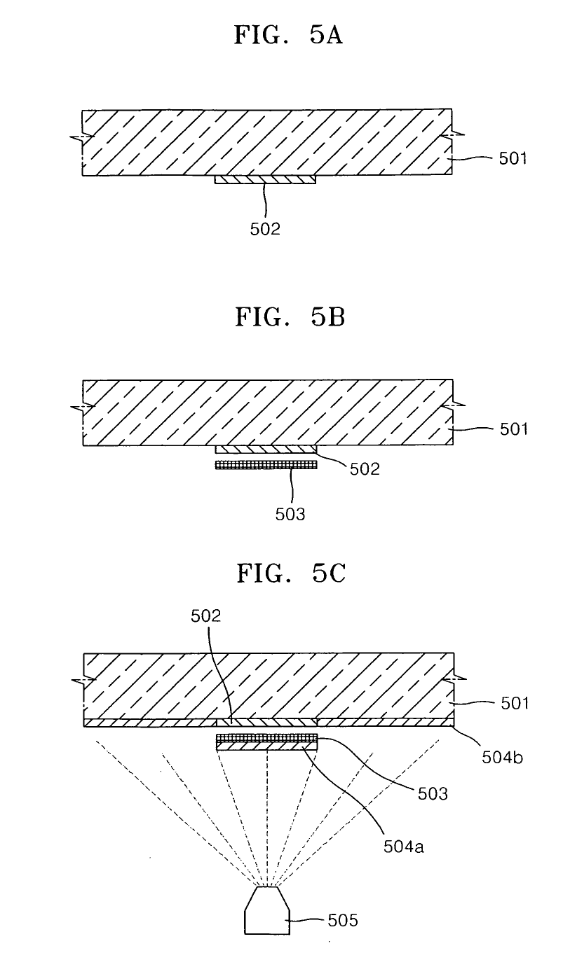

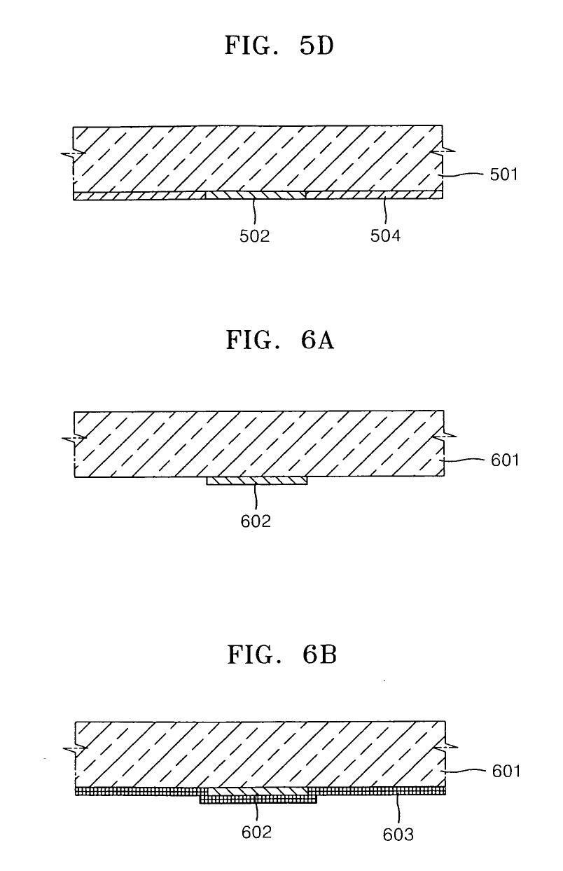

FIGS. 5A through 5D are cross-sectional views for illustrating a method of fabricating the optical reflection layer according to an embodiment.

Referring to FIG. 5A, an electrode 502 is patterned on a substrate 501.

Referring to FIG. 5B, after the electrode 502 is patterned, a shadow mask 503 is aligned on the substrate 501. The shadow mask 503 has a particular pattern corresponding to an optical reflection layer to be formed in a subsequent process. The shadow mask 503 is aligned on the substrate 501 by separating a region where the optical reflection layer will be formed and a region where the optical reflection layer will not be formed.

Referring to FIG. 5C, a raw material for forming an optical reflection layer is sprayed onto the substrate 501 using a method selected from a CVD method, a plasma enhanced chemical vapour deposition (PECVD) method, a sputtering method, a molecular beam epitaxy (MBE) method, or a modified organometallic chemical vapour deposition (MOCVD) method using a coating apparatus 505.

As a result, the raw material for forming an optical reflection layer is coated on the substrate 501. The raw material for forming an optical reflection layer is coated on an outside surface 504a of the shadow mask 503 and on the surface 504b of the substrate 501 where the shadow mask 503 is not formed since the shadow mask 503 is formed on the substrate 501.

Through the processes described above, the electrode 502 is formed on the substrate 501 and an optical reflection layer 504 is formed on the substrate 501 where the electrode 502 is not formed. In this way, the optical reflection layer 504 can be formed in various patterns according to the particular patterns of the shadow mask 503. Also, since the optical reflection layer 504 is formed using a method selected from a CVD method, a PECVD method, a sputtering method, a MBE method, or a MOCVD method using the shadow mask 503 as a shielding film, the optical reflection layer 504 having a particular pattern can be formed.

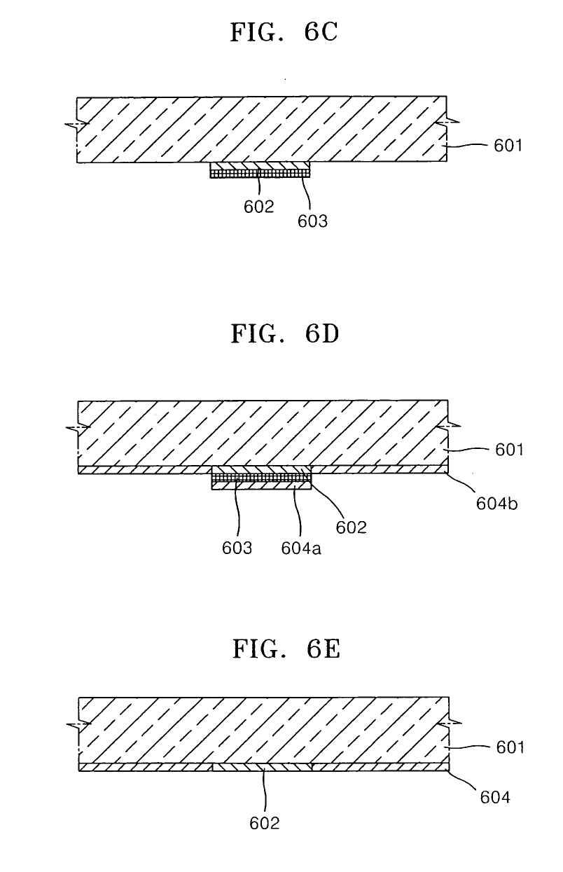

FIGS. 6A through 6E are cross-sectional views for illustrating a method of fabricating an optical reflection layer according to another embodiment.

Referring to FIG. 6A, an electrode 602 is patterned on a substrate 601.

Referring to FIG. 6B, after the electrode 602 is patterned, a photoresist 603 is coated on the entire surface of the substrate 601.

Referring to FIG. 6C, after the photoresist 603 is coated on the substrate 601, only the photoresist 603 coated on the electrode 602 is patterned and the rest of the photoresist 603 coated on the substrate 601 is removed using exposure and developing processes.

Referring to FIG. 6D, as described with reference to FIG. 5C, a raw material for forming an optical reflection layer is sprayed on the entire surface of the substrate 501 using a method selected from a CVD method, a PECVD method, a sputtering method, a MBE method, or a MOCVD method. As a result, an area for coating the raw material for forming an optical reflection layer includes a portion 604a of coating formed on an outside of the photoresist 603 and a portion 604b of coating formed on a region where the photoresist 603 is removed.

Through the processes described above, the electrode 602 is formed on the substrate 601 and an optical reflection layer 602 is formed on the substrate 601 where the electrode 602 is not formed. Also, the photoresist 603 formed on the electrode 602 is removed. In this way, the optical reflection layer 602 can be formed to a desired pattern using a lift-off method.

As described above, a transmissive type or reflective type display apparatus according to the present embodiments and a method of fabricating the display apparatus can increase the reflectance of visible light since an optical reflection layer is formed in a sealed inner space, and thus, can increase brightness and light emission efficiency of the display apparatus.

Also, since the optical reflection layer can be formed using a shadow mask or a lift-off process, a high resolution and high definition display apparatus can be fabricated and with reduced fabrication costs and high productivity.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A display apparatus comprising:
a first substrate that allows visible light to pass therethrough;
a second substrate facing the first substrate;
an anode disposed on the first substrate;
a cathode disposed on the second substrate;
an electron emitter disposed either on the anode or the cathode;
a light emitting layer formed on a surface of the anode;
an optical reflection layer disposed on a side of the second substrate; and
a gas that generates ultraviolet rays and is filled in a space between the first substrate and the second substrate.

2. The display apparatus of claim 1, wherein the electron emitter is disposed on the anode.

3. The display apparatus of claim 1, wherein the electron emitter is disposed on the cathode.

4. The display apparatus of claim 1, further comprising a grid electrode on the electron emitter.

5. The display apparatus of claim 1, wherein the optical reflection layer is formed in a region where electrons are not transmitted.

6. The display apparatus of claim 1, wherein the optical reflection layer is formed to have one layer or more using a white dielectric layer or a thin film metal layer.

7. The display apparatus of claim 1, wherein the gas that generates ultraviolet rays is selected from the group consisting Xe, N₂, heavy hydrogen, CO₂, H₂, CO, Kr, air or a mixture thereof.

8. The display apparatus of claim 1, wherein the anode, cathode and grid electrode each independently comprise a transparent conductive film.

9. The display apparatus of claim 8, wherein the transparent conductive film is indium tin oxide.

10. The display apparatus of claim 1, wherein the anode, cathode and grid electrode each independently comprise a metal film having high conductivity.

11. The display apparatus of claim 10, wherein the metal film having high conductivity is selected from the group consisting of Ag and Al.

12. The display apparatus of claim 1, wherein the light emitting layer comprises at least one of the group consisting of a photo luminescence phosphor layer, a cathode luminescence phosphor layer and a quantum dot phosphor layer.

13. The display apparatus of claim 12, wherein the light emitting layer comprises at least two of the group consisting of a photo luminescence phosphor layer, a cathode luminescence phosphor layer and a quantum dot phosphor layer.

14. The display apparatus of claim 1, wherein the electron emitter comprises at least one of the group consisting of oxidized porous silicon and oxidized porous amorphous silicon.

15. The display apparatus of claim 1, wherein the electron emitter comprises boron nitride bamboo shoot.

16. The display apparatus of claim 1, wherein the electron emitter has a thickness of from 0 nm to about 10 nm and the optical reflection layer has a thickness of about 100 nm or more.

17. The display apparatus of claim 6, wherein the white dielectric layer comprises Al₂O₃.

18. A method of fabricating a display apparatus comprising:
patterning an electrode on a substrate;
aligning a shadow mask on the substrate by separating a portion of the substrate where the electrode is formed and a portion of the substrate where the electrode is not formed; and
selectively forming an optical reflection layer on the substrate except the region on the electrode which is shielded by the shadow mask.

19. The method of claim 7, wherein the forming of the optical reflection layer comprises coating a raw material for forming an optical reflection layer on the substrate using a method selected from the group consisting of a CVD method, a PECVD method, a sputtering method, a MBE method, and a MOCVD method.

20. A method of fabricating a display apparatus comprising:
patterning an electrode on a substrate;
coating a photoresist layer covering the electrode on the substrate;
patterning the photoresist layer on a region of the substrate corresponding to the electrode by exposing and developing the substrate;
forming an optical reflection layer on the substrate; and
removing the remaining photoresist layer.
